(19) United States
(12) Patent Application Publication
(10) Pub. No.: US 2021/0245186 A1
(43) Pub. Date: Aug. 12, 2021

(54) Lawn fast spray bottle

(71) Applicant: Kamal Mehbub Sekhon, Glen Allen, VA (US)

(72) Inventor: Kamal Mehbub Sekhon, Glen Allen, VA (US)

(21) Appl. No.: 16/974,395

(22) Filed: May 4, 2021

Related U.S. Application Data
(60) Provisional application No. 62/968,282, filed on Jan. 31, 2020.

(51) Int. Cl. B05B 9/08

(52) U.S. Cl. CPC B05B 9/0805

(57) ABSTRACT

The Lawn Fast Spray Bottle has an Air valve that allows the user to put air into the sprayer by using an air compressor. The added air value is located at top side (shoulder) of the bottle.

### CROSS REFERENCE APPLICATION RELATES TO APPLICATION

Cross reference application relates to application Ser. No. 16/974,395, filed Jan. 12, 2021

### FIELD OF THE INVENTION

The spray bottle is used in Lawn and Garden. Lawn Fast Spray Bottle has an additional feature an Air Value.

### BACKGROUND

The lawn sprayers have existed on the market for long time, and have manual built in hand pump. The Lawn Fast Spray Bottle has an additional feature Air Valve that makes the bottle easier and faster to use while reducing user's physical effort, it helps the users that may not have the strength or ability to pump air with manual air pump. The added air valve (invention) allows the users to put air into the spray bottle by using the air compressor to build pressure instead of using the built-in hand pump. To better understand the Lawn Fast Spray Bottle invention please refer to the drawing.

### SPECIFICATION

The invention is the additional air valve installed on the Lawn Fast Spray Bottle's shoulder. This Air value is used to put air in the bottle to build air pressure with an air compressor.

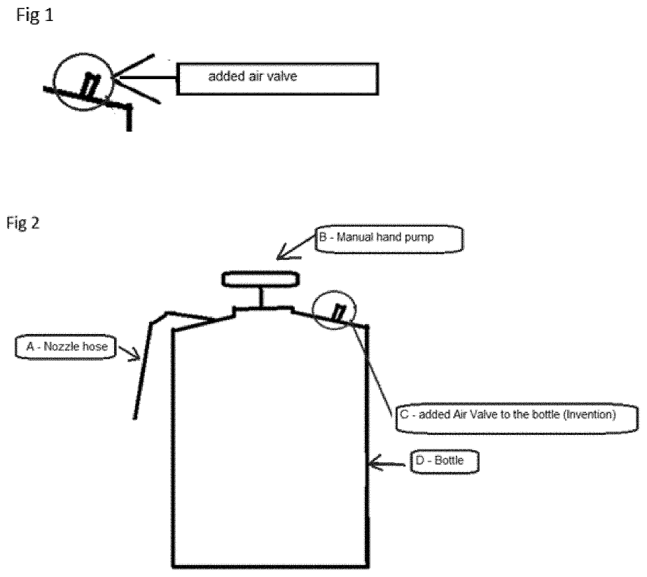

FIG. 1—Shows the added Air Value located on the Lawn Fast Spray Bottle.

FIG. 2—Shows Fast Lawn Spray Bottle with the added Air Valve.

A. Nozzle hose
B. Manual hand pump
C. Added Air Valve to the bottle (the invention)
D. Bottle

1. The added air valve (invention) is to allow the users to put air into the spray bottle by using the air compressor to build pressure instead of using the built-in hand pump.

2. The added air valve reduces user's physical effort, it helps the users that may not have the strength or ability to pump air with manual air pump.

3. The added air valve makes it faster to build the air pressure, and saves time.
